(19) United States
(12) Patent Application Publication
(10) Pub. No.: US 2020/0249036 A1
(43) Pub. Date: Aug. 6, 2020

(54) METHOD AND APPARATUS FOR MOVING OBJECT SHARING IN FLEET SYSTEM

(71) Applicants: HYUNDAI MOTOR COMPANY, Seoul (KR); KIA MOTORS CORPORATION, Seoul (KR)

(72) Inventors: Jae Jun HA, Hwaseong-si (KR); Young Jun MOON, Sejong-si (KR)

(73) Assignees: HYUNDAI MOTOR COMPANY, Seoul (KR); KIA MOTORS CORPORATION, Seoul (KR)

(21) Appl. No.: 16/775,775

(22) Filed: Jan. 29, 2020

(30) Foreign Application Priority Data
Jan. 31, 2019 (KR) 10-2019-0012921
Mar. 8, 2019 (KR) 10-2019-0027106

(51) Int. Cl. G01C 21/34; G08G 1/00; G05D 1/00

(52) U.S. Cl. CPC G01C 21/3438; G01C 21/3484; G05D 2201/0213; G05D 1/0027; G08G 1/202

(57) ABSTRACT

A method of providing a moving object sharing service includes: registering a first device and a first moving object in the fleet system; performing, by a processor, authentication that allows the first device to receive the moving object sharing service through the first moving object; and when the authentication is completed, controlling the first moving object by the first device. In particular, the first device may include setting information for a user of the first device, and the first moving object may change moving object state information on the basis of the setting information.

### CROSS REFERENCE TO RELATED APPLICATION

This application claims priority to and the benefit of Korean Patent Application No. 10-2019-0012921, filed on Jan. 31, 2019, and Application No. 10-2019-0027106, filed on Mar. 8, 2019, the entirety of each of which are hereby incorporated by reference.

### FIELD

The present disclosure relates to a method and apparatus for providing moving object sharing service through a fleet system.

### BACKGROUND

The statements in this section merely provide background information related to the present disclosure and may not constitute prior art.

As technology advances, the concept of vehicle ownership is weakening, and the use of shared vehicles is increasing. For example, vehicle sharing or vehicle pool. However, the existing sharing vehicle does not reflect various styles of individual users.

We have discovered that in the case of sharing a vehicle, the satisfaction level of the service is not high yet compared to the privately owned vehicle, and it is difficult to provide the vehicle security and service because the vehicle sharing system is not properly installed in the vehicle.

In addition, the vehicle has evolved into various types of moving means which is a moving object, and hereinafter the present disclosure will be described below with reference to the moving object.

### SUMMARY

The present disclosure provides a method and apparatus for providing moving object sharing service through a fleet system.

The present disclosure also provides a method and apparatus for providing a sharing service for a personal moving object through a fleet system.

The present disclosure provides a method and apparatus for operating a system that provides the sharing service for a personal moving object through a fleet system.

The present disclosure provides a method and apparatus for controlling the personal moving object sharing service through a fleet system.

According to one form of the present disclosure, a method of providing moving object sharing service in a fleet system comprises: registering a first device and a first moving object in the fleet system; performing, by a processor, authentication that allows the first device to receive the moving object sharing service through the first moving object; and when the authentication is completed, controlling the first moving object by the first device. In particular, the first device includes setting information for a user of the first device, the first moving object changes moving object state information on the basis of the setting information, the first moving object is a moving object among a plurality of moving objects registered in the fleet system to provide the moving object sharing service, and the first device is a device among a plurality of devices registered in the fleet system to receive the moving object sharing service.

In one form, the moving object state information includes at least one of: a position of a driver seat, a height of the driver seat, an interior illumination color, an interior illumination brightness, a position of a room mirror, an angle of the room mirror, a position of a side-view mirror, an angle of the side-view mirror, a temperature in a vehicle, an angle of a steering wheel, a tire pressure, an autonomous driving function setting variable, a driving mode, a cluster display mode, a navigation setting, a multimedia content setting, or a wireless communication connection mode.

In another form, when the first moving object is controlled by the first device, driving information for the first moving object is provided to the first device.

In one form, the first device updates the setting information for the user on the basis of the driving information.

In one form, the driving information is reflected in the setting information for the user and thus updated on the basis of machine learning and learning algorithm.

In one form, the fleet system has the plurality of moving objects including the first moving object and the plurality of devices including the first device registered to provide the moving object sharing service, and the registered moving objects and devices perform the moving object sharing service on the basis of the fleet system.

In one form, the moving objects and the devices registered in the fleet system are configured with list information, and the list information includes at least one of usage state information, device location information, or moving object location information.

In one form, the usage state information includes at least one of information on a moving object in use, estimated time information on a moving object in use, device-moving object matching information, deactivated device information, activated device information, deactivated moving object information, or activated moving object information.

In one form, the fleet system further includes state information on the plurality of moving objects, and determines whether to activate the moving object on the basis of the state information.

In one form, when the first device is maintained to be coupled to the first moving object after the authentication is completed, the first moving object is controlled by the first device.

According to another form of the present disclosure, a moving object for providing moving object sharing service in a fleet system comprises: a transceiver configured to transmit and receive a signal; and a processor configured to control the transceiver. In particular, the processor performs authentication that allows the moving object sharing service to be provided to a first device registered in the fleet system, and provides control authority of the moving object to the device when the authentication is completed. In one form, the first device includes setting information for a user of the first device, the moving object changes the moving object state information on the basis of the setting information, the first moving object is any one of a plurality of moving objects registered in the fleet system to provide the moving object sharing service, and the first device is any one of a plurality of devices registered in the fleet system to receive the moving object sharing service.

According to other form of the present disclosure, a method of providing moving object sharing service in a fleet system comprises: performing, by a processor, authentication that allows a first device to receive the moving object sharing service from a moving object provided through the fleet system; and controlling the moving object by the first device when the authentication is completed. In particular, the first device includes setting information for a user of the first device, the moving object changes moving object state information on the basis of the setting information, the moving object is a moving object registered in the fleet system by a second device, and the fleet system provides the moving object sharing server for the moving object on the basis of a sharing condition set through the second device.

In one form, the sharing condition is set on the basis of at least one of use time information, movable area information, point of departure information, or destination information of the moving object.

In one form, when the first device uses the moving object sharing service through the fleet system, the first device transmits, to the fleet system, at least one of the point of departure information, the destination information, and the use time information in order to use the moving object.

In one form, the fleet system provides the moving object to the first device for the moving object sharing service when the information transmitted by the first device satisfies the sharing condition.

In one form, the moving object state information includes at least one of a position of a driver seat, a height of the driver seat, an interior illumination color, an interior illumination brightness, a position of a room mirror, an angle of the room mirror, a position of a side-view mirror, an angle of the side-view mirror, a temperature in a vehicle, an angle of a steering wheel, a tire pressure, an autonomous driving function setting variable, a driving mode, a cluster display mode, a navigation setting, a multimedia content setting, and a wireless communication connection mode.

In one form, when the moving object is controlled by the first device, driving information for the moving object is provided to the first device.

In one form, the first device updates the setting information for the user on the basis of the driving information.

In one form, the driving information is reflected in the setting information for the user and thus updated on the basis of machine learning and learning algorithm.

In one form, after the authentication is completed, when detecting that the first device is located within a predetermined distance from the moving object and completing identification of the moving object, the moving object changes the moving object state information on the basis of the setting information provided by the first device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating a method in which a moving object communicates with another device through a network;

FIG. 2 is a diagram illustrating a method of sharing a moving object on the basis of a fleet system;

FIG. 3 is a diagram illustrating a moving object authentication method in a fleet system;

FIG. 4 is a diagram illustrating a method of applying a user's driving characteristic to a moving object through a fleet system;

FIG. 5 is a diagram illustrating a method of collecting and learning driving characteristic information in a fleet system;

FIG. 6 is a flowchart illustrating a method of updating driving information in a fleet system;

FIGS. 7A and 7B are diagrams illustrating a method of sharing a personally provided moving object through a fleet system.

FIGS. 8A and 8B respectively illustrate a method of providing the moving object sharing service in consideration of a moving object type;

FIG. 9 is a diagram illustrating a method of collecting and learning driving characteristic information in a fleet system;

FIGS. 10A, 10B, and 10C are views illustrating methods of coupling a device to a moving object in a fleet system; and

FIG. 11 is a diagram illustrating a configuration of a fleet system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinbelow, exemplary forms of the present disclosure will be described in detail so that those skilled in the art can easily carry out the present disclosure referring to the accompanying drawings. However, the present disclosure may be embodied in many different forms and is not limited to the forms described herein.

In the following description of the forms of the present disclosure, a detailed description of known functions and configurations incorporated herein will be omitted when it may make the subject matter of the present disclosure rather unclear. Parts not related to the description of the present disclosure in the drawings are omitted, and similar parts are denoted by similar reference numerals.

In the present disclosure, when a component is “connected”, “coupled”, or “fixed” to another component, it means that the component is not only directly connected to the another component, but also the component is indirectly connected to the another component with other component interposed therebetween. In addition, when a component “includes” or “has” another component, it means that the component may further include another component without excluding other components, unless specifically stated otherwise.

In the present disclosure, terms such as first and second are used only for the purpose of distinguishing one component from other components, and do not limit the order or importance between the components unless specifically mentioned. Accordingly, within the scope of the present disclosure, a first component in one form may be referred to as a second component in another form, and likewise, a second component in one form may be referred to as a first component in another form.

In the present disclosure, the components distinguished from each other are for clearly describing each feature, and do not necessarily mean that the components are separated. That is, a plurality of components may be integrated into one hardware or software unit, or one component may be distributed and formed into a plurality of hardware or software units. Therefore, even if not mentioned otherwise, such integrated or distributed forms are included in the scope of the present disclosure.

In the present disclosure, components described in various forms do not necessarily mean essential components, and some of them may be optional components. Therefore, one form composed of a subset of components described in one form is also included in the scope of the present disclosure. In addition, forms including other components in addition to the components described in the various forms are included in the scope of the present disclosure.

Advantages and features of the present disclosure, and methods for achieving them will be apparent with reference to the forms described below in detail with reference to the accompanying drawings. However, the present disclosure is not limited to the forms set forth below, but may be implemented in various forms, and only the present forms make the disclosure of the present disclosure complete, and are provided to fully inform those of ordinary skill in the art of the scope of the present disclosure.

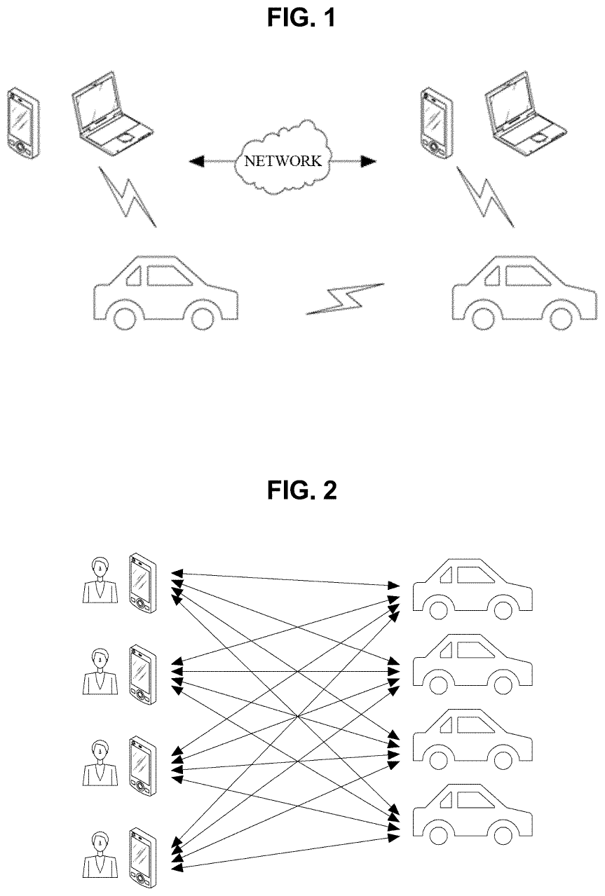

FIG. 1 is a diagram illustrating a method in which a moving object communicates with another moving object or device through a network. Referring to FIG. 1, a moving object may communicate with another moving object or device. Herein, as an example, the moving object may communicate with another moving object or another device based on cellular communication, WAVE communication, dedicated short range communication (DSRC), or other communication schemes. That is, as a cellular communication network, a communication network such as LTE, 5G, WiFi communication network, WAVE communication network, etc. may be used. In addition, a local area network used in a moving object, such as DSRC may be used, and the present disclosure is not limited to the above-described form. The moving object may have a device capable of performing communication, in which the device may communicate with another device.

In addition, for example, for the purpose of security of the moving object with respect to communication of a moving object, a module capable of communicating only with a device inside the moving object and a module capable of communicating with a device outside the moving object may exist separately. For example, inside a moving object, communication based on the security may be performed for only a device within a certain range in the moving object, such as Wi-Fi communication. For example, the moving object and a personal device owned by the moving object driver may include a communication module for performing only communication with each other. That is, the moving object and the personal device of the moving object driver may use a communication network disconnected from an external communication network and may use an in-vehicle network (in-moving object network). Also, as an example, the moving object may include a communication module for performing communication with an external device. Accordingly, the moving object may receive the necessary information from the outside and operate through the fleet system according to the information.

In addition, FIG. 2 illustrates a method of providing the moving object sharing service through a fleet system. For example, a fleet system may be applied to provide the moving object sharing service. Herein, the fleet system may be a system including a plurality of devices and a plurality of moving objects. Herein, each of the plurality of moving objects may be owned by a specific owner. That is, there is a separate owner for each of a plurality of moving objects, and other users are allowed to use the moving object through the fleet system. For example, a separate owner device may correspond to each of the plurality of moving objects. That is, each moving object has a device corresponding to the owner. Also, as an example, there is a device for each user using each moving object. Herein, the users may use the moving object on the basis of each device. Hereinafter, for convenience of description, a device for an owner is referred to as an owner device, and a device for a user is referred to as a tenant device. However, this is merely an example for convenience of description and the present disclosure is not limited thereto. Also, for example, the owner device and the tenant device may be smart devices. In addition, the owner device and the tenant device may be devices such as a smart watch or other decoration worn on a person. As another example, the owner device and the tenant device may be SIM cards. For example, the SIM card may be included in a portable device. As another example, the owner device and the tenant device may be separate devices for the fleet system. That is, the owner device and tenant device may be devices for recognizing the moving object, and the present disclosure is not limited thereto.

Also, as an example, the moving object may be a car or vehicle. Also, as an example, the moving object may be an object that moves over area such as a rail. As another example, the moving object may be a flying object such as a drone. That is, the moving object may refer to a movable object, and may mean a moving object shared through the fleet system. However, the following is described with respect to a car or vehicle for convenience of description, but it may be equally applied to other moving objects.

For example, referring to FIG. 2, the above-described moving objects and devices may be always connected through a network on the basis of a fleet system. More specifically, in a fleet system, a particular moving object may be always connected with the device for the moving object owner. For example, the moving object may provide the service through the fleet system only when the moving object is connected to the device of the moving object owner, and the present disclosure is not limited thereto. In addition, as an example, a plurality of moving objects and devices of tenants capable of using the moving objects in the fleet system may be always connected through a network. That is, the tenants may check information on the moving objects provided on the basis of the fleet system in real time through their own devices, and a service operation may be performed using the moving object on the basis of the information. Meanwhile, as another example, moving objects and devices connected to each other through the fleet system may be limited to moving objects and devices included in a specific group. For example, a large number of moving objects and devices may be registered in the fleet system. Herein, unnecessary overhead may occur and service may not be smoothly provided when the moving objects and the devices registered in the fleet system are connected to each other. In view of the foregoing, the fleet system may provide connections of moving objects and devices included in a specific group. That is, the management of service provision may be performed on a group in which moving objects and devices are connected to each other in a fleet system. Meanwhile, the moving object and the device of the moving object owner may be connected with devices of tenants in a group in which the owner is included. In addition, the tenant device is always connected to moving objects in a group in which the tenant is included. Accordingly, the tenant may check the moving object status in real time to determine whether to use the moving object. That is, a plurality of devices and a plurality of moving objects may be connected to each other, as described above. Hereinafter, a method of recognizing a moving object which is intended to be used by the tenant and using the moving object on the basis of the recognition will be described.

As another example, a road side unit (RSU) may be an infrastructure communication node. In addition, as an example, the RSU may refer to a structure installed to transmit and receive signals to a building or other area, and the present disclosure is not limited thereto. However, hereinafter, the RSU generally referred to for convenience of description may be various structures or devices, and the present disclosure is not limited thereto.

In addition, the fleet system may be a vehicle sharing system. The fleet system may be a system in which vehicles are shared in a certain area. Herein, the certain area may be a local concept, such as an apartment complex, a working area, and the like. For example, the certain area may include an area inside the apartment complex and an area spaced a predetermined distance from the apartment complex. As another example, the certain area may mean an area spaced a predetermined distance from the work place. As another example, the area to which the fleet system is applied may be a larger area or a city unit in terms of an administrative area, and the present disclosure is not limited thereto. That is, the certain area may mean a reference range capable of being operated through the fleet system, and may be changed by the user or the system. In addition, as an example, the fleet system may refer to as a vehicle sharing system in which a specific user (or devices) authenticated share a vehicle. For example, a specific user may be an apartment resident who may be provided with the fleet system service. For example, the fleet system may provide a vehicle sharing service on the basis of devices registered by apartment residents. This allows the sharing service to be provided only to the specific user, thereby increasing moving object security and manageability. However, the specific user who uses the shared vehicles in the fleet system may be determined according to different methods, and the present disclosure is not limited thereto. The vehicle sharing fleet system may be provided with shared vehicles. Herein, the shared vehicle may be a vehicle authenticated and authorized to be shared by the system. For example, the shared vehicle may be a vehicle registered in the fleet system. Herein, the fleet system manager may supply shared vehicles with the fleet system. That is, only vehicles authenticated or authorized by the fleet system manager may be used as the shared vehicles. This enables preventing accidents caused by security or management of the shared vehicles in the fleet system. More specifically, the fleet system may have the shared vehicles registered. An authority to register a vehicle as the shared vehicles in the fleet system may be limited by the fleet system. Herein, the vehicles capable of being registered in the fleet system may have the same ID or the same identification information to each other. In addition, the fleet system provides the shared vehicles while managing the same. For example, the management of the shared vehicles may be desired to provide shared moving object service, such as residual oil information, moving object state information, or moving object driving information for a vehicle registered in the fleet system. Herein, the fleet system may check the state of the shared vehicle in real time, and in the case of a vehicle in which failure occurs, the fleet system may limit an authority for use thereof or transmit a repair command therefor through the system, thereby providing the service in such a manner.

In addition, as an example, the RSU may be a communication node that is disposed at a predetermined distance or periodically on the road. In addition, as an example, the RSU may be a node which is disposed at a specific point on the road to communicate with the moving object. As another example, the RSU may refer to a traffic infrastructure terminal capable of communicating. As another example, the RSU may refer to a device capable of communicating, as a V2X terminal, a peripheral moving object, or the other moving object. That is, the RSU generally refers to a device capable of communicating with the moving object. Hereinafter, the RSU will be comprehensively referred for convenience of description.

As another example, the fleet system may provide a shared moving object provided by the system, as well as a private moving object owned by an owner as described above. For example, the fleet system may set identification information for distinguishing shared moving objects provided by the system from privately owned moving objects. To the end, a privately owned moving object indication field may be provided. When the privately owned moving object indication field is 0, it may indicate that the shared moving object is a moving object provided by the system provider without private ownership. Meanwhile, when the privately owned moving object indication field is 1, it may indicate that the moving object is privately owned and provided as a shared moving object to the fleet system, which is shown in Table 1 below. That is, the case where the privately owned moving objects and the shared moving objects provided by the system are mixed on the basis of the above description may also be considered. Herein, as an example, the service provided by the fleet system may be varied according to the moving object type indication field. For example, in the case of a moving object provided by the fleet system, there may be no usage limit for a user who uses the moving object. Meanwhile, the usage limit may exist in the case of a privately shared moving object. As another example, the fleet system moving object and the privately shared moving object may provide the service on the basis of billing systems different from each other, and the present disclosure is not limited thereto.

TABLE 1

| Moving object type | |
|---|---|
| indication field | Indication information |
| 0 | Moving object provided by fleet system |
| 1 | Privately shared moving object |

As another example, in relation to a specific operation of the fleet system, the service may be provided on the basis of a device registered in the fleet system.

More specifically, the device registered in the fleet system may obtain shared moving object information after the authentication and security procedures for the system. That is, the shared moving object information may be provided to the device. Herein, the device may contact the moving object that is to be used on the basis of the information on the shared moving object.

For example, there may be moving objects or devices (or users) registered in the fleet system. Herein, the moving object registered in the fleet system may be a privately owned moving object as described above. For example, when a privately owned moving object is registered in the fleet system, the fleet system may provide incentive information in consideration of a situation in which the privately owned moving object is leased to another person. For example, the fleet system may determine the incentive information on the basis of at least one of a type, a state, years old, and a lease time for a privately owned moving object that is provided. That is, the fleet system may calculate the incentive information about the privately owned moving object provided to the tenant and provide the same to the owner of the privately owned moving object. For example, the owner of a privately owned moving object may receive a certain reward from the fleet system on the basis of the incentive information. In addition, as an example, the incentive information may be utilized as information for using the fleet system, and the present disclosure is not limited thereto.

In addition, for example, only a specific moving object and device may be registered in the fleet system on the basis of authentication and authorization. Herein, the fleet system may be operated on the basis of state information of the registered moving object and device. For example, the fleet system may check information about a moving object currently being used and location information about an individual moving object in real time. Herein, for example, each moving object may periodically transmit its information to the fleet system. In addition, for example, each moving object may transmit its information to the fleet system on the basis of the event trigger. For example, when an event of a change in location or use of a moving object is triggered, the moving object may transmit its information to the fleet system (or server). In addition, the fleet system (or server) may check the information on the registered device in real time. Herein, as an example, the registered device may not always use the service of the fleet system. Therefore, activation information indicating whether the registered device uses the service of the fleet system may be needed. Herein, as an example, the fleet system may include list information about registered devices. Among registered devices included in the list of fleet system, a device that is currently using a moving object or activates the system for use of a moving object may be provided as the list information. As another example, the devices may be classified into a registered device (deactivated device) that does not use the fleet system, a registered device (activated device) that is using a moving object of the fleet system, and a registered device (temporary device) that is to use a moving object. That is, it is possible to provide information about whether a device is actually in use, whether there is a use intention of a device, and whether a device is not used yet even with a use intention. In addition, as an example, usage state information may be further indicated for a device using a moving object of the fleet system. For example, the usage state information may further include use estimated time information, use location information, or the like.

In more detail, the fleet system may include list information about a plurality of moving objects and a plurality of devices that are registered. Herein, the list information may include at least one of usage state information, device location information, and moving object location information. Herein, the fleet system may provide the moving object sharing service on the basis of the device location information and the moving object location information. In addition, the above-described usage state information may include at least one of information on a moving object in use, estimated time information on a moving object in use, device-moving object matching information, deactivated device information, activated device information, deactivated moving object information, and activated moving object information. Herein, as an example, the usage state information may further include information on moving object in use that is being used by another device and estimated time information on the moving object in use. In addition, the usage state information may further include device-moving object matching information on the basis of the list form information. In addition, the usage state information may include activated device information and deactivated device information. For example, as described above, the activated device information may be a device that is currently using the moving object or preparing to use the moving object among devices registered in the fleet system. For example, the activated device may mean a device that executes a program or an application for the fleet system. Meanwhile, the deactivated device may be a device that is registered in the fleet system but does not use moving object sharing. For example, the deactivated device may be a device that does not execute or deactivate a program or application for the fleet system.

In addition, the fleet system may include activated moving object information and deactivated moving object information. In this case, as an example, the fleet system may include state information about a plurality of moving objects. In this case, the state information on the moving object may be information on the moving object, such as information on whether there is a moving object abnormality, information on remaining distance to drive, or information on a time of refueling. That is, the moving object state information may be information for determining whether the moving object may be provided for moving object sharing, and the present disclosure is not limited thereto. Herein, the fleet system may determine whether to activate the moving object on the basis of the above state information. For example, when a moving object has no abnormal condition and a sufficient amount of fuel, the fleet system may classify the moving object into an activated moving object, whereas when a moving object has an abnormal moving object condition, the fleet system may classify the moving object into a deactivated moving object. Herein, the fleet system may provide information on the deactivated moving object to an associated system or server. For example, the associated system or server may perform repair or management on a deactivated moving object, and the present disclosure is not limited thereto.

In addition, as an example, when a moving object has an amount of fuel below a predetermined level, the fleet system may classify the moving object into a deactivated moving object, as described above. As another example, when a moving object having an amount of fuel below a predetermined level is shared through a device, the fleet system may notify the device user of information about the amount of fuel. In addition, as an example, the fleet system may provide a user with information about an associated specific system (e.g., a gas station of a specific brand), in which information indicating that refueling is required may be provided. Herein, the fleet system may exchange information on the billing or other necessary information with the associated specific system regardless of the user, thereby providing the service in such a manner.

That is, a user using the moving object sharing system may refuel the moving object at a designated place without paying a cost, and the cost may be processed through the system associated with the fleet system.

Meanwhile, for example, as described above, the device (temporary device) may check the fleet system to use the moving object.

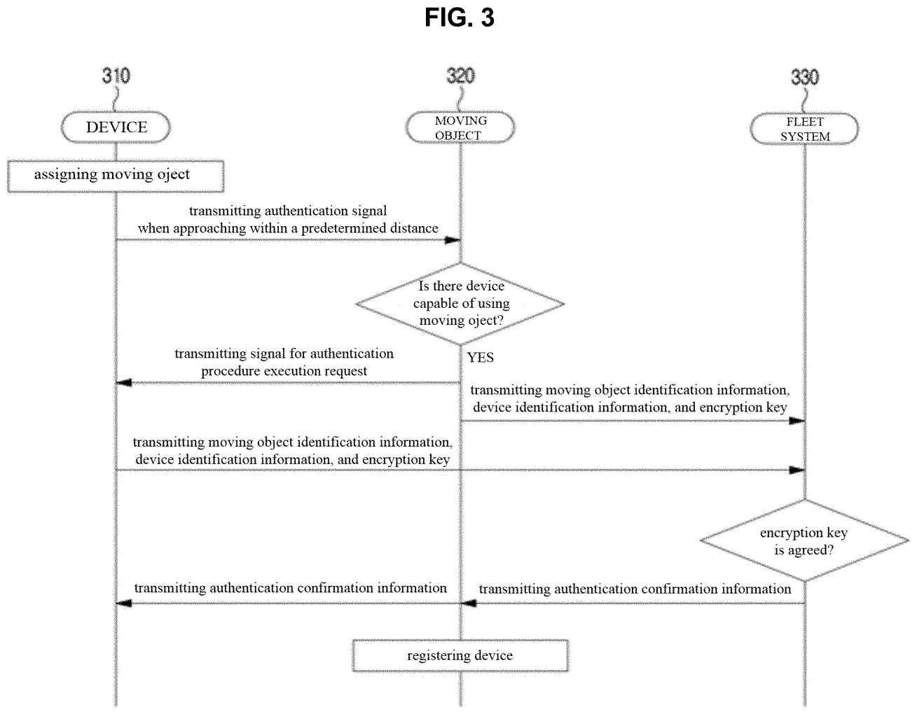

For example, referring to FIG. 3, the device 310 may be assigned a moving object 320 that is to be used through a fleet system (or server) 330. Herein, for example, the fleet system (or server) 330 may be configured to assign the moving object 320 to the device 310 by using at least one of information on the moving object 320 in use, location information of the moving object, and location information of the device. Meanwhile, as an example, when the fleet system 330 does not allocate the moving object 320, the fleet system 330 may provide the device 310 with information on the failure. In addition, as an example, the fleet system 330 may allocate only the moving object 320 within a predetermined distance with respect to the location of the device 310, and the present disclosure is not limited thereto. Next, the device 310 may approach the moving object 320 within a predetermined distance. Herein, the device 310 may transmit an authentication signal to the moving object 320. In addition, as an example, the device 310 may use the shared moving object 320 by tagging the shared moving object on the basis of a list of available shared moving objects. For example, the device 310 may tag a moving object through NFC, Bluetooth, or a magnetic such as a traffic card. Herein, when the device 310 tags the shared moving object, the shared moving object 320 may perform an authentication procedure through the fleet system 330 so that the device 310 may provide the moving object 320. For example, when the authentication is completed on the basis of the device tagging, the door of the moving object 320 may be opened.

With respect to a more specific operation for authentication, referring to FIG. 3, when the device 310 approaches the moving object 320 within a predetermined distance, an authentication signal may be transmitted to the moving object 320. Herein, the communication available by the moving object 320 and device 310 may be Bluetooth, NFC, or magnetic card as described above. That is, a procedure for authentication may be performed under certain conditions, and the present disclosure is not limited thereto. When the device 310 approaches (or tags) the moving object, the moving object and the device may exchange signal so that the device 310 may be authenticated by determining whether the device 310 may use the moving object. Herein, the device 310 may transmit, to the moving object, an authentication signal including its own identification information and identification information of a group in which the device 310 is included. Herein, the moving object 320 may check whether the device 310 is a device registered in the fleet system 330 on the basis of the identification information of the device 310 included in the received authentication signal. In addition, the moving object 320 may determine whether the device 310 is included in a group capable of providing the service on the basis of the identification information of the group included in the authentication signal. That is, the moving object 320 may determine whether the device 310 may use the moving object 320 on the basis of the device identification information and the group identification information. For example, when the device 310 does not use the moving object 320, the moving object 320 may transmit information about the unavailability to the device 310. For example, the device 310 may obtain the information about the unavailability from an application or another service providing program.

Meanwhile, when the device 310 may use the moving object 320, the moving object 320 may transmit a signal for authentication procedure execution request to the device 310. That is, when the device 310 is legally registered in the above-described fleet system 330, and the moving object 320 may also legally operate on the basis of the fleet system 330, the moving object 320 performs the signal for authentication procedure execution request to the device 310. Herein, the moving object 320 may also transmit moving object identification information and encryption key information included in the authentication procedure execution request signal to the device 310. For example, both the moving object identification information and the device information may be registered in the fleet system. Herein, the moving object 320 may transmit a signal including the moving object identification information, the device identification information, and the encryption key information to the fleet system 330.

In addition, the device may also transmit, to the fleet system, the signal including the moving object identification information, the encryption key information, and device identification information included in the signal for authentication procedure execution request.

Thereafter, the fleet system 330 may compare signal information received from the moving object 320 with signal information received from the device 310. Herein, when the moving object identification information, the device identification information, and the encryption key information all agree, the fleet system 330 may recognize that the device 310 may use the moving object. Thereafter, the fleet system 330 may transmit authentication confirmation information to the moving object 320 and the device 310. Herein, the fleet system 330 may register information indicating that the device 310 uses the moving object 320, in a database. In addition, as an example, the time for which the device 310 uses the moving object 320 and additional information may be continuously transmitted.

In addition, the moving object 320 may register the device on the basis of the authentication confirmation information and is allowed to open the door. In addition, a lock may be released to use the moving object, whereby the device 310 may control the moving object.

Herein, for example, when the above-described authentication is completed, the moving object 320 and the device 310 may periodically exchange signals. That is, while the device 310 uses the moving object 320, the moving object 320 may periodically exchange signals with the device 310, thereby continuously confirming the usage thereof.

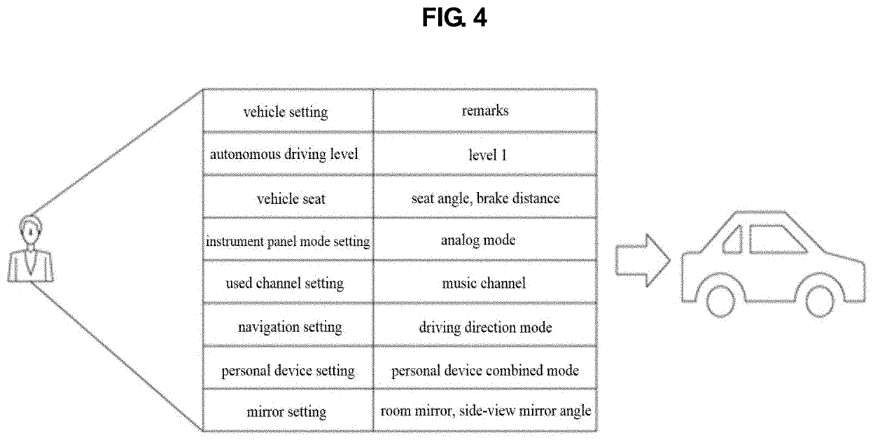

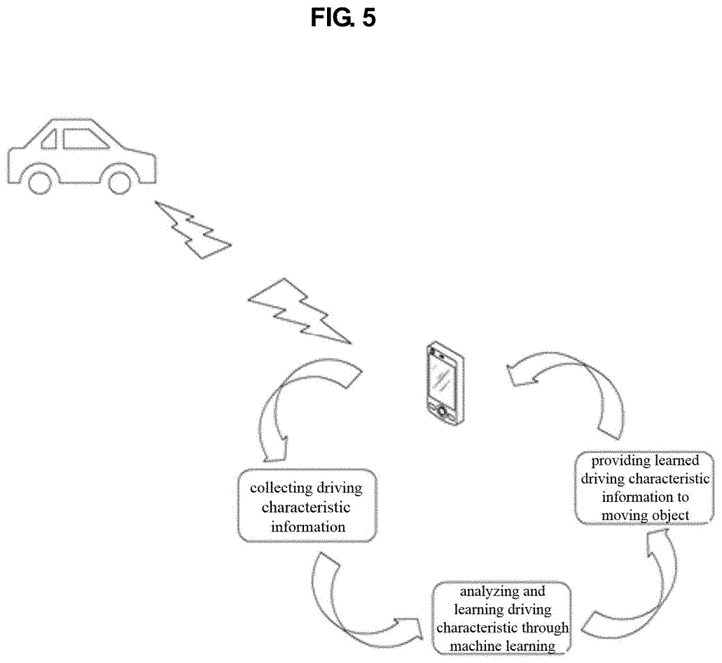

Herein, for example, referring to FIG. 4, the device may provide the moving object with personal style information or user information. For example, the device may include information about autonomous driving level setting, moving object seat, instrument panel mode setting, used channel setting, navigation setting, personal device setting, mirror setting, and the like, as personal style information. However, this is only one example and the present disclosure is not limited thereto. That is, the moving object provided by the fleet system may be in the form of communicating with a personal device having a personal driving characteristic stored in a learned manner. Accordingly, even when a privately owned moving object is provided with the tenant, it is possible to provide the service customized to the tenant. That is, the running performance and driving environment of the moving object may be converted in such a manner as to be customized to the user, and then provided to the user. As described above with reference to FIG. 4, the information may be converted into a form customized to a user and then provided. More specifically, according to the driving characteristic set in the personal device, it is possible to provide various driving environments, such as a position and height of a driver's seat, a color and brightness of an interior light, a position and angle of room mirror and side-view mirror, a temperature control (air conditioner and heater) range in vehicle, an angle of a steering wheel, a tire pressure, a driving mode (normal, eco, power mode, etc.), a wireless communication connection mode (WAVE, cellular, etc.), an autonomous driving function setting variable range (speed and interval, lane change lateral speed, acceleration and deceleration, etc.), and the like.

Herein, for example, the fleet system may improve user convenience and accident prevention efficiency for a shared vehicle by changing the vehicle setting on the basis of the above information. Specifically, the setting for vehicle driving may be varied for each user, and when each user uses a vehicle that does not match his/her own setting, an accident may occur due to inexperienced driving or the like. Therefore, the risk of an accident may be increased when the shared vehicle is used. In consideration of the foregoing, when the fleet system provides the sharing service through the shared vehicle, the vehicle setting may be varied through the above-described information on the basis of the user's personal style.

Herein, for example, for the purpose of the above-described operation, tenant setting information may be stored in the tenant device. Herein, when the tenant uses the moving object, a tenant device may be associated with the moving object. For example, as described above, when the tenant device is associated with the moving object, the tenant setting information may be provided to the moving object, and the operation may be performed as described above. As another example, when the tenant device is associated with the moving object and the tenant uses the moving object, tenant driving information may be updated in the device. That is, the device may be updated on the basis of information obtained from the rented moving object as moving object driving information for the tenant. Thereafter, the device may update the tenant setting information and further utilize the update information when renting another moving object later. That is, tenant history information is managed by the tenant device, and the tenant may use the related information when the tenant uses a privately owned moving object. Meanwhile, for example, when the tenant device is associated with a moving object, usage information for the moving object may be transmitted to an owner device. For example, when the owner device is associated with the tenant device in the case that the moving object is used by the tenant, the owner device may continuously check information on whether to rent the moving object. This allows the owner device to continuously check information about the owner's moving object.

Herein, for example, since settings for moving object driving may be varied for each user, there may be an increased risk of accidents due to inexperienced driving when each user uses a moving object that does not match his/her own setting. Therefore, the risk of an accident may be increased when a shared moving object is used. In consideration of the foregoing, when the fleet system provides the sharing service through the shared moving object, the moving object setting may be set differently through the above-described information according to a user's personal style.

As another example, a case may be considered in which a tenant reuses a previously used moving object through the fleet system. For example, when the moving object is shared through the fleet system, the same tenant may often use the same moving object on the basis of the similar living pattern. In consideration of the foregoing, the tenant device may store history information about the moving object once used. In addition, for example, the moving object may store history information about the tenant device used once. Herein, for example, when the moving object and the tenant device perform initial setting at the time of initial authentication, a plurality of procedures for authentication and identification may be performed. However, as described above, when the tenant device or the moving object includes the usage history information, the additional procedure may be omitted by performing only the basic authentication for the use of the moving object. For example, when the tenant device performs only basic authentication on the moving object, the moving object setting may be automatically changed on the basis of the previous usage history. For example, the history information may include usage history information, driving pattern information, personal style information, driving propensity information, and the like on the basis of the tenant device, and the present disclosure is not limited thereto. Herein, for example, based on the above-described history information, the moving object may further perform additional setting on the tenant device, and the present disclosure is not limited thereto.

In addition, in a specific example in which the device uses the shared moving object, the device may check a list of shared moving objects provided and select the shared moving object from among the list. Herein, when the device is adjacent to or in contact with the shared moving objects, the shared moving objects may be used with respect to the device. Herein, the shared moving object setting or other related settings are changed with respect to the device so that the device user may use the shared moving object. Herein, the moving object setting information reflects the user's preference or style, so that not only security and authentication related settings but also contents may be changed. For example, a form displayed on the shared moving object may be changed on the basis of the interface set in the device, whereby the shared moving object may be operated on the basis of the form. That is, as described above, when the device approaches the shared moving object, the shared moving object may be changed and used with respect to the device.

Herein, for example, a vehicle may be designed so that the setting is changed on the basis of the above-described information. As another example, in the case of a vehicle provided by a fleet system among shared vehicles, it is possible to perform the setting change in consideration of personal style as described above. Meanwhile, when the personal vehicle is shared, the above-described change may be limited by reason of vehicle security and design reason, and the present disclosure is not limited thereto. That is, in the case of providing a shared vehicle through the fleet system, the fleet system may differently set levels of security and design changes for the vehicle on the basis of the shared vehicle information, thereby increase user convenience. That is, the device may set the information about the vehicle driving. Herein, each user may preset vehicle usage information in consideration of his driving habits or driving patterns. Herein, when the user uses the shared vehicle, an accident risk or a moving object operation mistake may be caused by using a vehicle that is not familiar to the user. In consideration of this, the device may include setting information with respect to the device in the case of using the shared vehicle.

Herein, for example, the device may check a list of shared vehicles provided and select a shared vehicle among from the list. Herein, when the device is adjacent to or in contact with the shared vehicle, the shared vehicle may be used with respect to the device. Herein, shared vehicle settings or other related settings may be changed with respect to the device so that the device user may use the shared vehicle. Herein, the vehicle setting information reflects a device user's preference or style, thereby changing not only setting related to security and authentication but also contents. For example, a form displayed on the shared vehicle may be changed on the basis of the interface set in the device.

That is, as described above, when the device approaches the shared vehicle, the shared vehicle may be changed and used with respect to the device.

As another example, referring to FIG. 5, the above-described information may be information that is continuously learned through machine learning. More specifically, referring to FIG. 4, the personal style information or driver information may be set by a user. However, the driver may also not know the information accurately in many cases. That is, the driver may not be able to confirm clearly the exact value and setting of the information. Herein, for example, a user's personal device may collect information on driving characteristic on the basis of information on shared vehicle usage. For example, the driver may adjust some settings of fundamental settings on the basis of the driving characteristic information while using the shared vehicle. In addition, the above-described settings may be changed in consideration of a driving state or a specific situation during driving. Herein, the user may be aware of the changes described above, but may not be aware of the correct numerical values or values related thereto. In consideration of the foregoing, the personal device may collect information on vehicle driving or information on driving characteristic. Thereafter, the personal device may continuously update setting information that is customized to the user through machine learning or learning algorithm. Herein, when the number of times the user uses the shared vehicle increases, the related information may be growing. Herein, the device may analyze and learn the driver style and other information on the basis of above-described information. Thereafter, the device may apply the above-described change information when using the shared vehicle next time. That is, since the user may not quantify and input the driving characteristic information or other information, the information is automatically obtained through machine learning or learning algorithm, thereby providing the service.

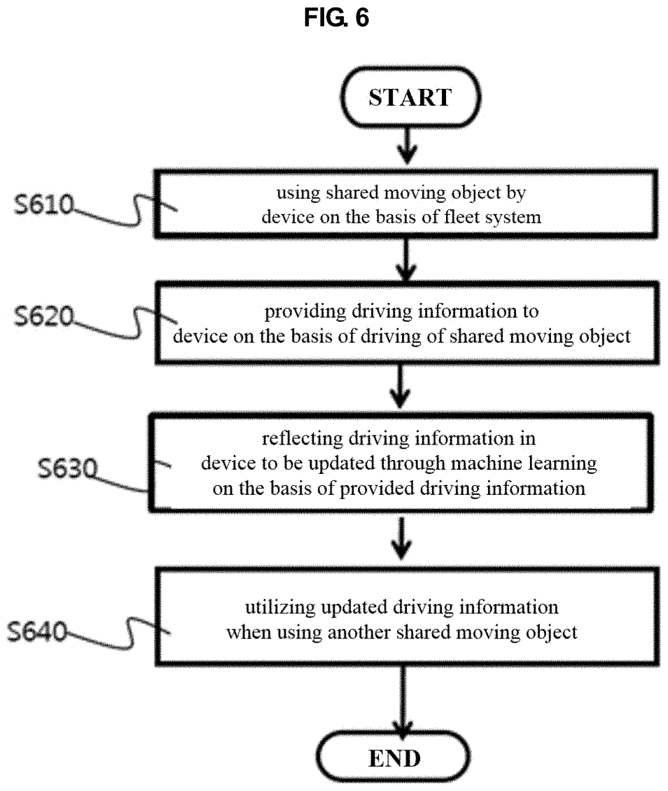

For example, FIG. 6 is a flowchart illustrating a method in which driving information is updated. Referring to FIG. 6, a device may use a shared vehicle on the basis of a fleet system (S610). Herein, as described above, driving characteristic information or other information set in the device may be reflected in a vehicle to change the settings of the vehicle. Herein, for example, driving characteristic information or other information may be information related to driving. That is, the driving information as the information related to the use of the moving object may refer to the information on the setting. Herein, when the device uses the shared vehicle, the shared vehicle may provide the driving information to the device on the basis of the driving of the shared vehicle (S620). That is, when the device user is using the vehicle, the driving information may be provided to the device. Herein, the device may reflect the driving information in the device to be updated through machine learning or learning algorithm on the basis of the provided driving information (S630). Herein, for example, since a device user may have difficulty to quantify and input the information related to the vehicle setting, as described above, the driving information or the vehicle setting information are continuously updated on the basis of the usage information on the shared vehicle, and thus becomes information customized to a user. Next, the device may utilize the updated driving information when using another shared vehicle, as described above (S640).

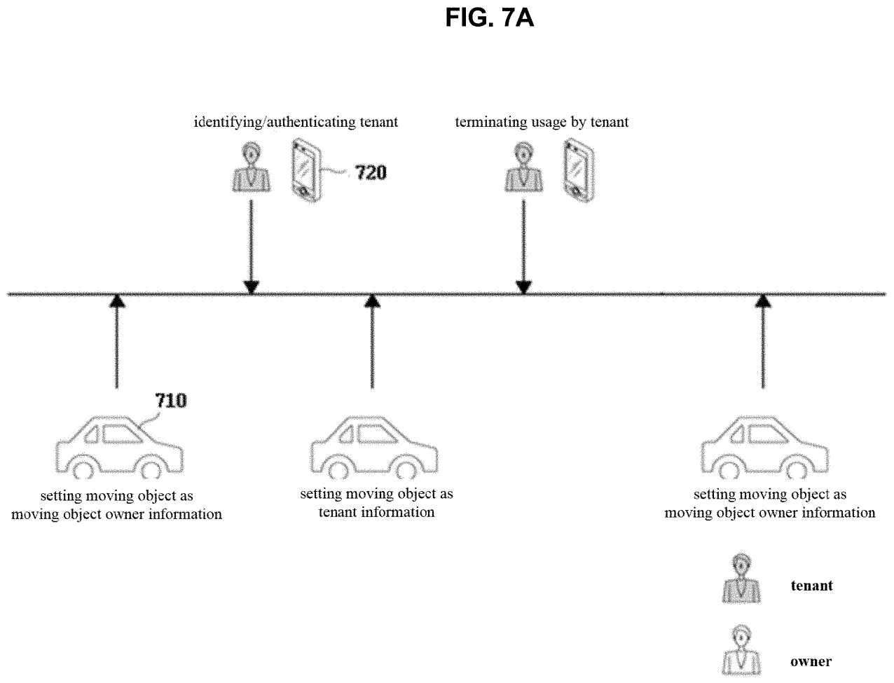

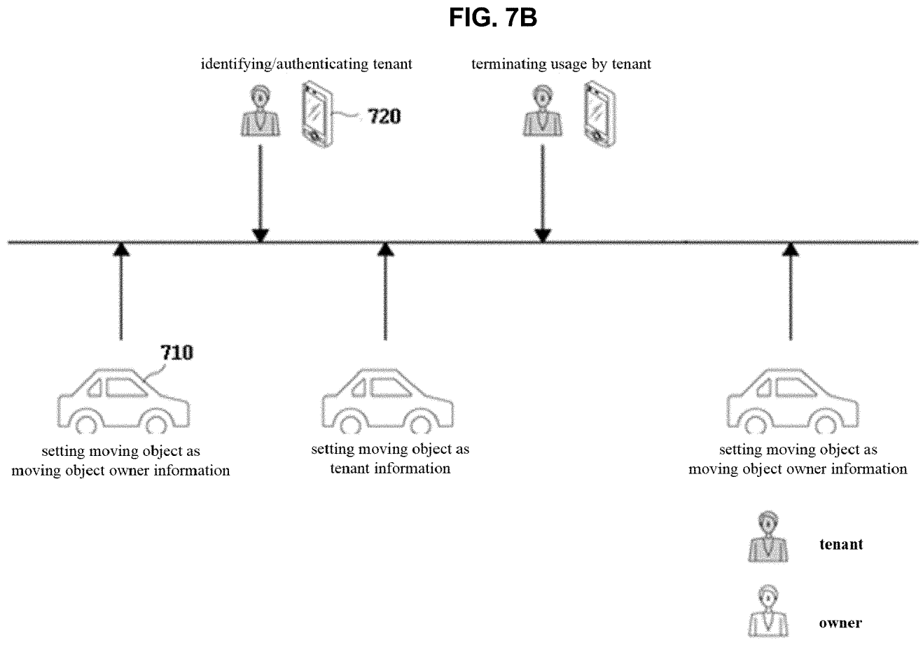

More specifically, referring to FIGS. 7A and 7B, a privately owned moving object 710 may be provided to the tenant by the fleet system. Herein, for example, a privately owned moving object 710 may be set with moving object owner information before being provided to the tenant. For example, the information described above with reference to FIG. 4 may be set on the basis of the moving object owner information. Thereafter, a privately owned moving object 710 may be provided to the tenant by the fleet system. Herein, condition should be set to share the privately owned moving object 710. For example, the condition may be set on the basis of at least one of a moving object use time, a movement restriction area, a point of departure, a destination, and a moving object state. For example, the owner device 730 corresponding to the privately owned moving object 710 may set a condition in which the privately owned moving object 710 is shared. As an example, the owner device 730 may have an application for a fleet system. Herein, information about sharing conditions may be entered by the owner through the application. Thereafter, the owner device 730 may transmit the input information to the fleet system, thereby providing the moving object sharing service. Meanwhile, as an example, the fleet system may set a rating for the above-described sharing condition. The fleet system may provide high incentive information when the rating is high, whereas the fleet system may provide low incentive information when the rating is low. That is, low incentive information may be provided when many conditions are set as the sharing condition and there are many restrictions for providing the shared service, whereas high incentive information may be provided when many conditions are not set as the sharing condition and the shared service may be provided relatively easily. For example, the owner device 730 may receive additional services from the system on the basis of the incentive information. For example, when the owner device 730 uses another moving object as a shared moving object, the owner device 730 may receive the service based on the above incentive information. That is, the incentive information may be a kind of reward, and the fleet system may be operated according to the foregoing.

Meanwhile, the tenant may obtain information on the available moving object from the fleet system on the basis of the sharing conditions described above. For example, an application for a fleet system may exist in the tenant device 720. Herein, the tenant device 720 may set information on a point of departure, a destination, and a use time, and search for moving objects capable of being shared on the basis of the information. Herein, the moving objects capable of being shared may have the point of departure, the destination, and the use time present within an allowable range on the basis of the sharing conditions described above. Then, the tenant may select a particular moving object and perform identification and authentication on the basis of the fleet system. When the identification and authentication are completed on the basis of the fleet system, the tenant device 720 may use the moving object 710. Herein, when the tenant device 720 approaches the moving object 710 or performs moving object recognition in a predetermined manner, the tenant device 720 may use the moving object 710. Herein, for example, the tenant device 720 may store tenant setting information as shown in FIG. 4. Herein, when the tenant device 720 is allowed to use the moving object 710, the tenant device 720 may provide tenant setting information to the moving object 710. Herein, the moving object 710 may change the setting on the moving object on the basis of the information received from the tenant device 720. For example, as described above, the instrument panel information or the degree of autonomous driving may be set on the basis of the tenant device 720. This allows the tenant to use the moving object in a familiar environment even when using another moving object. Thereafter, the case where the tenant device 720 terminates the use of the moving object 710 may be considered. Referring to FIG. 7A, the moving object 710 may additionally provide the sharing service to another tenant device, and thus may maintain the setting. Herein, another tenant device performs identification and authentication on the basis of the fleet system, and when the moving object 710 is used, the moving object setting may be changed on the basis of the setting information of another tenant device. Meanwhile, when the tenant terminates the use of the moving object and the moving object owner device 730 completes identification and authentication of its moving object 710, the setting information for the moving object 710 may be changed on the basis of the moving object owner information stored in the owner device 730. That is, when the moving object sharing is terminated, the moving object may be returned to the existing state on the basis of the setting information of the moving object owner, and the moving object owner may use the moving object in the same manner as the existing state.

For example, referring to FIG. 7B, when tenant device 720 finishes using the moving object 710, the setting information for the moving object 710 may be changed to the setting information for the owner device 730. That is, when the use of the tenant device 720 is terminated, the moving object 710 is immediately returned to the setting of the existing owner device 730 so that the owner device 730 may conveniently use the moving object 710 in the existing state. In other words, even when the moving object owner shares his/her moving object with the tenant, the moving object owner may directly use his/her setting information without changing the setting information, thereby reducing the inconvenience caused by providing the shared service. Herein, for example, when other tenant device uses the moving object 710, the other tenant device completes identification and authentication so that the moving object may be changed to setting information for the other tenant device, and the present disclosure is not limited thereto.

In addition, as an example, when the moving object 710 travels through the tenant device 720, setting information of the tenant device 720 may be updated. For example, the tenant setting information may include driving related information, and the tenant device 720 may update the related information on the basis of the information obtained during using the moving object 710. As another example, the setting information may be changed by the tenant device 720. The tenant may change the corresponding setting information through an application in the tenant device 720. When setting the moving object, the setting information may be more accurately set to conform to the user when the user seats in the moving object or changes the settings during using the moving object. In consideration of the foregoing, when the tenant device 720 is using the moving object 710, the tenant may change the setting of the moving object 710. Herein, the change in the setting information for the moving object may be transmitted to the tenant device 720, and the tenant device 720 may reflect the information and store the related information in the tenant device 720. That is, the setting information for the tenant may be stored and updated in the tenant device 720. Herein, the tenant may utilize the above-described update information when using other moving object.

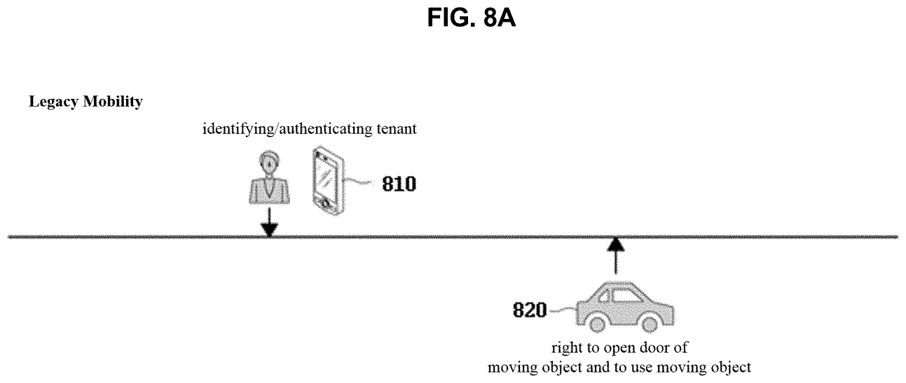

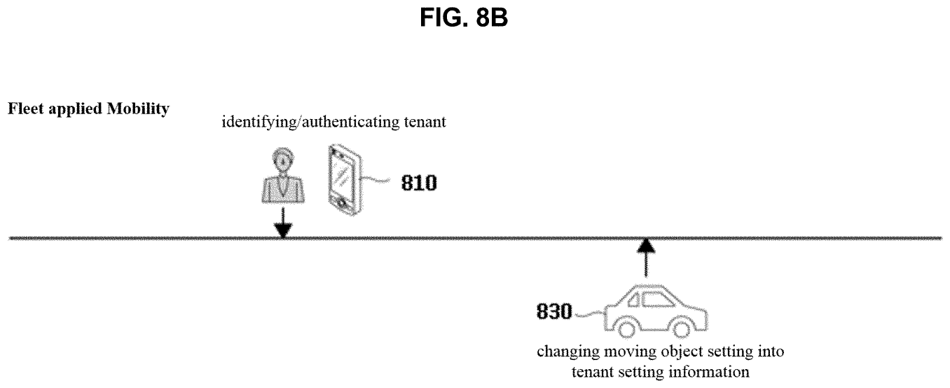

As another example, referring to FIG. 8, a legacy moving object and a fleet system applied moving object are considered. More specifically, when the shared moving object is provided by the fleet system, the shared moving object may not cause a problem in supporting an operation or a function provided by the fleet system. However, when a privately owned moving object is provided in the fleet system as a shared moving object, the privately owned moving object may not support all operations or functions provided by the fleet system. Herein, for example, the fleet system may provide the shared moving object service only for fleet system moving objects that support fleet system operation.

As another example, the moving object sharing service may be provided for moving objects that do not support all operations or functions in the fleet system in consideration of compatibility with the existing system or the legacy system. For example, a moving object that does not support all operations or functions in the fleet system may be referred to as a first type moving object. Meanwhile, a moving object that supports all operations or functions in the fleet system may be referred to as a second type moving object. That is, the fleet system may provide the moving object sharing service differently in consideration of the moving object type.

As a specific example, referring to FIG. 8A, the tenant device 810 may use the legacy moving object 820 through the fleet system. Herein, the legacy moving object 820 may be a moving object that may not change the moving object state based on the tenant setting information stored in the tenant device 810. That is, even when the tenant setting information is transmitted to the moving object 820, the moving object setting information may not be changed in the moving object 820. Herein, when the tenant device 810 completes identification and authentication of the legacy moving object 820, the fleet system may provide the user only with an authority to open the door of the moving object 820 and an authority to use the moving object 820. That is, the tenant device 810 may be provided only with an authority to use a specific moving object 820 through the fleet system, whereby the user may use the moving object 820.

Meanwhile, the fleet system applied moving object may operate as described above. For example, referring to FIG. 8B, the tenant device 810 may complete identification and authentication of the moving object 830 to which the fleet system may be applied on the basis of the fleet system. Herein, as described above, the tenant setting information stored in the tenant device 810 may be provided to the moving object 830, and the moving object 830 may change the moving object setting information on the basis of the tenant setting information, as described above. That is, the fleet system may provide the sharing service for the fleet system applied moving objects and the sharing service for the existing moving object, thereby performing operations having compatibility with the existing system.

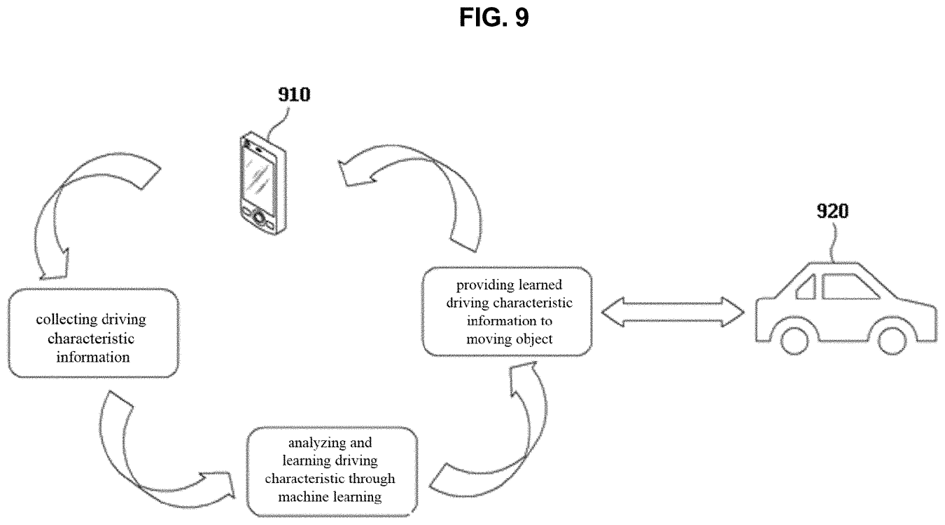

As another example, referring to FIG. 9, the above-described information may be continuously learned on the basis of machine learning. More specifically, the personal style or driver information may be information set by a user, referring on FIG. 4. However, the driver may not know the information accurately in many cases. That is, the driver may not be able to confirm clearly the exact value and setting of the information. Herein, for example, the user's personal device 910 may collect driving characteristic information on the basis of the shared moving object usage information. For example, the driver may conveniently adjust some settings of the fundamental settings on the basis of the driving characteristic information, during using the shared moving object 920. In addition, the above-described settings may be changed in consideration of a specific situation or a driving state during driving. Herein, the user may be aware of the changes described above, but may not be aware of them with the correct numerical values or values. In consideration of the foregoing, the personal device 910 may collect information on driving a moving object or information on a driving characteristic. Herein, the user may be aware of the changes described above, but may not be aware of the correct numerical values related thereto. In consideration of the foregoing, the personal device 910 may collect information on moving object driving or information on driving characteristic. Thereafter, the personal device 910 may continuously update setting information that is customized to the user through machine learning or learning algorithm. Herein, when the number of times the user uses the shared moving object increases, the related information may increase. Herein, the personal device 910 may analyze and learn the driver style and other information on the basis of above-described information. Thereafter, the personal device 910 may apply the above-described change information when using the shared moving object next time. That is, the user may not quantify and input the driving characteristic information or other information, which are automatically obtained through machine learning or learning algorithm, thereby providing the service. This allows the tenant to use the shared moving object on the basis of the same setting even when the tenant uses another moving object, thereby increasing the user's convenience.

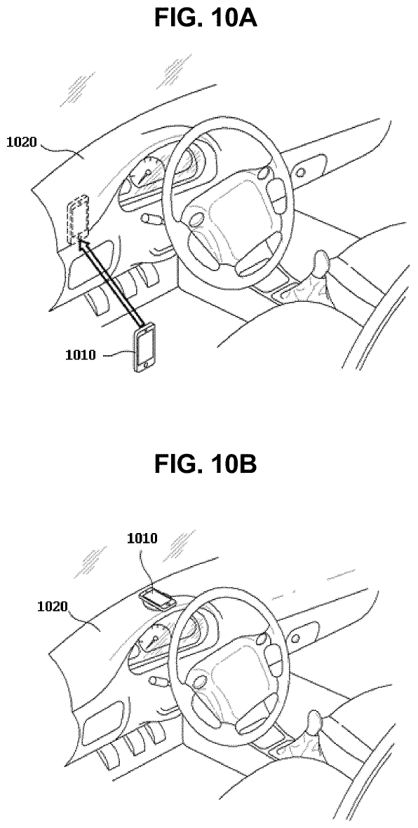

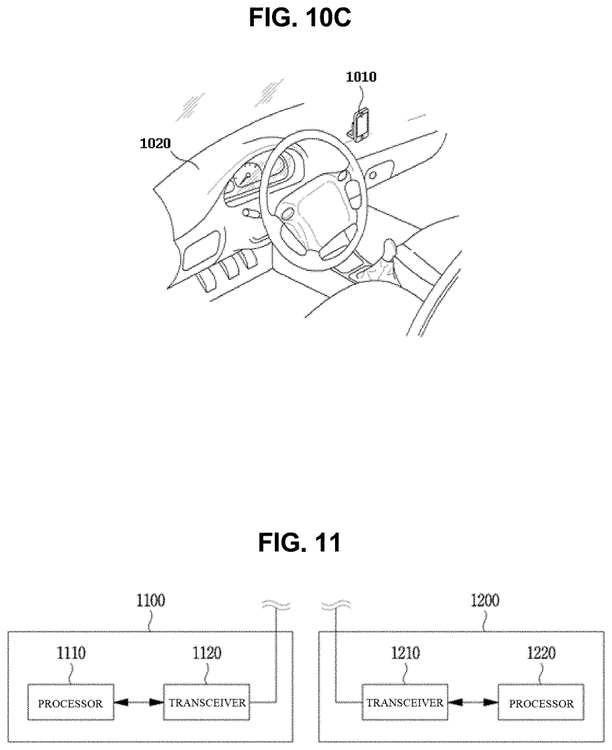

As another example, referring to FIGS. 10A 10B and 10C, the device 1010 may combined in the moving object 1020. In the case of moving object sharing, there may be a security problem. In addition, in the case that a specific device is used in combination with the moving object, when control authority of moving object is transited to other device, a risk of an accident may occur. In view of the foregoing, a method of increasing a level of security and authentication for the moving object may be needed. Herein, for example, the moving object 1020 may periodically transmit “in use” information to the fleet system while the moving object 1020 is being coupled to the device 1010 or is periodically exchanging signals with the device 1010. Herein, the fleet system may exclude the aforementioned moving object from a list of shared moving objects provided to other devices on the basis of the information received from the moving object. In addition, as an example, the moving object 1020 may periodically notify the fleet system of information about the case where the device 1010 is using the moving object 1020. For example, the moving object 1020 may periodically provide the fleet system with driving distance information, fuel amount information, movement route information, and other service information. Herein, for example, the fleet system may transmit charging information to the device 1010 on the basis of the information received from the moving object. In addition, as an example, the fleet system may provide usage information to the device 1010 on the basis of the information received from the moving object 1020, and may later calculate cost on the basis of the charging system, and the present disclosure is not limited thereto.

Herein, for example, as shown in FIG. 10A, the device 1010 may be combined with the moving object 1020 in such a manner as to be attached or coupled to the moving object. For example, as shown in FIG. 10B, the device 1010 may be located on the top portion in the moving object 1020. Herein, there may be a cradle or pad inside the moving object 1020 that causes the device 1010 to be coupled. Herein, the cradle or pad enables coupling the device 1010 to the moving object using the magnetic properties. For example, when the device 1010 performs authentication with the moving object 1020 as described above, the moving object 1020 may be controlled only when the device 1010 is attached to the above-described cradle or pad. That is, moving object state information of the moving object 1020 may be changed through authentication of the device 1010. Herein, the security level for usage of the moving object 1020 is increased, and the moving object 1020 may be controlled in a state in which the device 1010 is attached to the cradle or the pad, and the present disclosure is not limited thereto.

In addition, as an example, charging may be performed when the device 1010 is attached to the cradle or pad described above. In more detail, the device 1010 may be coupled to the moving object 1020 and then charged, so that the device 1010 may exchange information with the moving object 1020. For example, the device 1010 may be positioned to face the driving direction of the moving object 1020 within the moving object 1020 as shown in FIG. 10C. Herein, for example, the device 1010 may further display usage information of the moving object 1020 or driving information (e.g. navigation) of the moving object 1020, and the present disclosure is not limited to the above-described form. That is, the device 1010 may be attached or coupled to the moving object 1020 to perform identification and authentication, thereby providing the above-described fleet service.

For example, as described above, the device 1010 may remain coupled to provide the driving characteristic information to the device 1010 through machine learning or learning algorithm. That is, the device 1010 may provide personal driving characteristic information or setting information as described above only in a state where the device is coupled to the moving object. In this way, the device 1010 may acquire personal driving characteristic information or setting information only during actual driving or actual use as described above, whereby the actual information may be obtained through machine learning or learning algorithm and the customized service may be provided.

Meanwhile, for example, the shared moving object used in the fleet system may include a module for performing operations based on the fleet system. For example, the module may be an interface module for allowing the moving object and the device to recognize each other on the basis of the fleet system. As another example, a jack or an adaptor for recognizing the device may be further included in the moving object to clarify mutual recognition of the moving object and the device. That is, the fleet system may be operated on the basis of a separate module for using the shared moving object.

As another example, when the device registered in a fleet system may use the moving object through authentication as described above, the moving object needs to be associated with the device. For example, the moving object may detect that the device is adjacent to the moving object within a predetermined distance. Herein, when the device is adjacent to the moving object within the predetermined distance, the moving object may notify the device of information on whether to use the moving object. In addition, when the device is located within the predetermined distance, the moving object may communicate with the fleet system to cause the door to be automatically opened. In another example, the existing moving object could be managed and secured through a moving object key. Meanwhile, in the case of the shared moving object, the moving object user may be varied every time, and thus may not operate based on a certain key. That is, when the device is associated with the moving object to perform authentication through the fleet system, the moving object may be controlled. Each of the device and the moving object may include an application based on the fleet system. For example, the moving object may include an installation capable of implementing the application. As another example, the moving object may be provided as an installation for a fleet system through a detachable external device, and the present disclosure is not limited thereto. Herein, as an example, each of the device and the moving object may include cryptographic key information. Herein, the fleet system may exchange the cryptographic key information included in each of the device and the moving object so that the moving object may be controlled only when the authentication is enabled. Meanwhile, when the device uses a moving object, the moving object needs to prevent itself from being accessed by other devices. This makes it possible to prevent an accident from being caused when the device is collided with the other device. Herein, for example, when authentication is performed on the moving object and the device, the device may be used with being coupled to the moving object. For example, when the device is adjacent to the moving object on the basis of the fleet system, the moving object door may be opened. In order to secure stability on the fleet system, the device may be set to have a control authority of the moving object only when the device is coupled to the shared moving object. That is, opening the door of the moving object may have a relatively low security level, but it is desired to set the security level high in consideration of controlling the shared moving object with the device.

As another example, the fleet system may provide the moving object sharing service through communication with a RSU which is a peripheral infrastructure. For example, parking for a moving object registered as a shared moving object in the fleet system may be limited to a specified place. For example, the fleet system may create a group based on a predetermined area and provide the moving object sharing service by registering a plurality of moving objects in the group. Herein, as an example, the shared moving object may be parked only at a specified place in the area corresponding to the group. That is, the fleet system may perform parking management for the shared moving object and may perform management for location tracking. Herein, the fleet system may manage all moving objects only when the moving objects are parked at a specific place and the moving objects are used by the device. That is, the fleet system may efficiently distribute the moving objects through by checking the specific places and the used moving objects. Meanwhile, as an example, the fleet system may provide a command that forces the moving object to move through an administrator when the moving object distribution is not efficiently performed on the basis of the above-described management method, whereby the system may be smoothly operated.

As another example, the fleet system may manage moving objects using autonomous driving and the existing moving object, thereby providing the moving object sharing service. That is, the fleet system may provide the moving object sharing service on the basis of functions provided to each of moving objects including the legacy moving objects and the current moving objects.

In more detail, moving objects shared through the fleet system may provide the same function based on the same model. As another example, moving objects shared through the fleet system may provide different functions as different models from each other.

First, moving objects shared through the fleet system may provide the same function based on the same model. For example, the function may be an autonomous driving level. Herein, the autonomous driving function may be varied according to each autonomous driving level as autonomous driving information, and the present disclosure is not limited to the above-described form. In the above-described situation, the fleet system may provide all the functions provided by the moving object to the device using the moving object. In addition, as an example, the fleet system may provide only a part of functions provided by the moving object to the device using the moving object. Herein, a user corresponding to each device may have different proficiency in handling the moving object, and in consideration of accident prevention and stability, the fleet system may provide moving object functions on the basis of user information corresponding to the device. That is, when it is determined that all moving object functions are available based on the user information, the fleet system may grant all functions to the device. Meanwhile, when the fleet system determines that all moving object functions are not available on the basis of user information (e.g., driving experience, autonomous driving experience, etc.), the fleet system will allow the device to have some functions, thereby preventing accidents from occurring.

Meanwhile, for example, when the fleet system provides shared moving objects having different functions from each other, the fleet system may further provide function information with respect to the moving objects used by the device. More specifically, the fleet system may provide the device with moving object information in advance, in order to prevent an accident that may occur because a user of the device does not properly understand the moving object function, whereby the fleet system can prevent accidents from occurring in the shared moving object.

FIG. 11 is a diagram illustrating a configuration of a first device 1100 and a second device 1200. Referring to FIG. 11, each of the first device 1100 and the second device 1200 may be a device that performs communication. For example, the first device 1100 and the second device 1200 may include at least one of the above-described device, moving object, fleet system (or server), and RSU.

That is, the first device 1100 and the second device 1200 may be devices that communicate with each other. Herein, for example, the first device 1100 and the second device 1200 may include processors 1110 and 1120 and transceivers 1210 and 1220 for the above-described operation. That is, each of the first device 1100 and the second device 1200 may include a processor for controlling a communication operation and a related operation. In addition, each of the first device 1100 and the second device 1200 may include a transceiver, in consideration of the above-described operations.

While the example methods of the present disclosure described above are represented as a series of operations for clarity of description, it is not intended to limit the order in which the steps are performed, and each step may be performed simultaneously or in a different order as desired. In order to implement the method according to the present disclosure, the illustrated step may further include other steps, may include remaining steps except for some steps, or may include other additional steps except for some steps.

The various forms of the present disclosure are not an exhaustive list of all possible combinations, and are intended to describe representative aspects of the present disclosure, and the matters described in the various forms may be applied independently or in combination of two or more.

In addition, various forms of the present disclosure may be implemented by hardware, firmware, software, or a combination thereof. The hardware may be implemented by one or more of application specific Integrated Circuits (ASICs), Digital Signal Processors (DSPs), Digital Signal Processing Devices (DSPDs), Programmable Logic Devices (PLDs), Field Programmable Gate Arrays (FPGAs), a general processor, a controller, a microcontroller, a microprocessor, and the like.

It is intended that the scope of the disclosure includes software or machine-executable instructions (e.g., an operating system, an application, firmware, a program, etc.) that causes an operation in accordance with various forms to be executed on an apparatus or a computer, and non-transitory computer-readable media that are executable on a device or computer in which such software or instructions, and the like are stored.

What is claimed is:

1. A method of providing moving object sharing service in a fleet system, the method comprising:
registering a first device and a first moving object in the fleet system;
performing, by a processor, authentication that allows the first device to receive the moving object sharing service through the first moving object; and
when the authentication is completed, controlling the first moving object by the first device,
wherein:
the first device includes setting information for a user of the first device,
the first moving object is configured to change moving object state information based on the setting information,
the first moving object is a moving object among a plurality of moving objects registered in the fleet system and configured to provide the moving object sharing service, and
the first device is a device among a plurality of devices registered in the fleet system and configured to receive the moving object sharing service.

2. The method of claim 1, wherein the moving object state information includes at least one of:
a position of a driver seat,
a height of the driver seat,
an interior illumination color,
an interior illumination brightness,
a position of a room mirror,
an angle of the room mirror,
a position of a side-view mirror,
an angle of the side-view mirror,
a temperature in a moving object,
an angle of a steering wheel,
a tire pressure,
an autonomous driving function setting variable,
a driving mode,
a cluster display mode,
a navigation setting,
a multimedia content setting, or
a wireless communication connection mode.

3. The method of claim 1, wherein when the first moving object is controlled by the first device, driving information for the first moving object is provided to the first device.

4. The method of claim 3, wherein the first device is configured to update the setting information for the user based on the driving information.

5. The method of claim 4, wherein when the driving information is updated, the driving information is updated using machine learning or learning algorithm based on the setting information for the user.

6. The method of claim 1, wherein the fleet system has moving objects including the first moving object and the plurality of devices including the first device registered to provide the moving object sharing service, and
wherein the registered moving objects and devices perform the moving object sharing service based on the fleet system.

7. The method of claim 6, wherein:
the plurality of the moving objects and devices registered in the fleet system are configured with list information, and
the list information includes at least one of usage state information, device location information, or moving object location information.

8. The method of claim 7, wherein the usage state information includes at least one of information on a moving object in use, estimated time information on a moving object in use, device-moving object matching information, deactivated device information, activated device information, deactivated moving object information, or activated moving object information.

9. The method of claim 8, wherein the fleet system further includes state information on the plurality of moving objects, and is configured to determine whether to activate the moving object based on the state information.

10. The method of claim 1, wherein when the first device is maintained to be coupled to the first moving object after the authentication is completed, the first moving object is controlled by the first device.

11. A moving object for providing moving object sharing service in a fleet system, the moving object comprising:
a transceiver configured to transmit and receive a signal; and
a processor configured to:
control the transceiver,
perform authentication that allows the moving object sharing service to be provided to a first device registered in the fleet system, and
provide a control authority of the moving object to the device when the authentication is completed,
wherein the first device includes setting information for a user of the first device,
the moving object changes moving object state information based on the setting information,
the first moving object is one of a plurality of moving objects registered in the fleet system to provide the moving object sharing service, and
the first device is one of a plurality of devices registered in the fleet system to receive the moving object sharing service.

12. A method of providing moving object sharing service in a fleet system, the method comprising:
performing, by a processor, authentication that allows a first device to receive the moving object sharing service from a moving object provided through the fleet system; and
controlling the moving object by the first device when the authentication is completed,
wherein the first device includes setting information for a user of the first device,
the moving object is configured to change moving object state information based on the setting information,
the moving object is a moving object registered in the fleet system by a second device, and
the fleet system is configured to provide the moving object sharing service for the moving object based on a sharing condition set by the second device.

13. The method of claim 12, wherein the sharing condition is set based on at least one of use time information, movable area information, point of departure information, or destination information of the moving object.

14. The method of claim 13, wherein when the first device uses the moving object sharing service through the fleet system, the first device is configured to transmit, to the fleet system, at least one of the point of departure information, the destination information, and the use time information in order to use the moving object.

15. The method of claim 14, wherein the fleet system is configured to provide the moving object to the user of the first device for the moving object sharing service when the information transmitted by the first device satisfies the sharing condition.

16. The method of claim 12, wherein the moving object state information includes at least one of a position of a driver seat, a height of the driver seat, an interior illumination color, an interior illumination brightness, a position of a room mirror, an angle of the room mirror, a position of a side-view mirror, an angle of the side-view mirror, a temperature in a moving object, an angle of a steering wheel, a tire pressure, an autonomous driving function setting variable, a driving mode, a cluster display mode, a navigation setting, a multimedia content setting, or a wireless communication connection mode.

17. The method of claim 12, wherein when the moving object is controlled by the first device, driving information for the moving object is provided to the first device.

18. The method of claim 17, wherein the first device is configured to update the setting information for the user based on the driving information.

19. The method of claim 18, wherein when the driving information is updated, the driving information is updated using machine learning or learning algorithm based on the setting information for the user.

20. The method of claim 12, wherein after the authentication is completed, when detecting that the first device is located within a predetermined distance from the moving object and completing identification of the moving object, the moving object is configured to change the moving object state information based on the setting information provided by the first device.
